(19) United States
(12) Patent Application Publication
(10) Pub. No.: US 2024/0368038 A1
(43) Pub. Date: Nov. 7, 2024

(54) LOW-COST MANUFACTURING OF SILICA AEROGEL INSULATION NANOCOMPOSITES

(71) Applicant: THE RESEARCH FOUNDATION FOR THE STATE UNIVERSITY OF NEW YORK, Amherst, NY (US)

(72) Inventors: Shenqiang REN, Williamsville, NY (US); Massimigliano DI LUIGI, Williamsville, NY (US)

(21) Appl. No.: 18/771,464

(22) Filed: Jul. 12, 2024

Related U.S. Application Data
(63) Continuation of application No. PCT/US2023/060638, filed on Jan. 13, 2023.
(60) Provisional application No. 63/299,323, filed on Jan. 13, 2022.

(51) Int. Cl. C04B 35/14; C04B 38/00; C04B 38/02

(52) U.S. Cl. CPC C04B 35/14; C04B 38/0054; C04B 38/02; C04B 2235/3427; C04B 2235/5212; C04B 2235/775; C04B 2235/9653

(57) ABSTRACT

A method for forming a ceramic aerogel includes contacting a ceramic precursor, an additive, an anionic surfactant, a cationic surfactant, and a catalyst to form a mixture. The catalyst may include an acid or a base. The method further includes heating the mixture to form a precursor gel, mixing fibers with the precursor gel, and drying the resultant fiber containing precursor gel.

### CROSS-REFERENCE TO RELATED APPLICATIONS

This application is a continuation of PCT International Application No. PCT/US2023/060638 filed Jan. 13, 2023, which claims priority to U.S. Provisional Application No. 63/299,323 filed Jan. 13, 2022, the contents of which are herein incorporated by reference in their entirety.

### FIELD OF THE DISCLOSURE

The present disclosure relates to silica aerogel composites. More particularly, the composites may include fibers and may be used for insulation applications.

### BACKGROUND OF THE DISCLOSURE

Aerogels constitute one of the best thermal insulating materials, typically featuring remarkably low values of thermal conductivity (ultralow thermal conductivity values even less than that of air) due to their extremely high porosity (typically between 90 to 99%) comprised mostly of mesopores with an average size of approximately 10 nm. Other outstanding properties of aerogels include extremely high values of specific surface area (>500 m²/g), as well as low dielectric constant and index of refraction. Even though all these advantages of aerogels open up a vast range of applications—as a composite material, as an absorbent, as a sensor, as a catalyst, as a storage media, as a template, and in clothing, apparel, and blankets to name a few-aerogels are predominantly related to energy saving purposes, particularly as energy efficient insulation when used in windows, as aggregates for lightweight cement-based thermal renders, and for acoustic purposes are amongst the most relevant usability. However, two of their main disadvantages are associated with (i) a relatively high cost at industrial level, and (ii) their brittleness and lack of good mechanical properties as a consequence.

Metal oxides, metalloid oxides, polymers, and even metals have been employed to produce aerogels. However, one of the most popular materials used as a base component is silica mainly due to its tendency to form transparent-like products, as well as its relative case of synthesis. Sodium silicate solution (also known as waterglass) has recently become a very popular and widely used silica source in the synthesis of silica aerogels due to its low cost, which is particularly desired as it increases both feasibility and large-scale production at industrial level. However, waterglass may also contain a number of impurities that are not beneficial to the performance of the resulting aerogels, mainly affecting their thermal performance due to high values of thermal conductivity. Eradication of sodium ions, and impurities in general, is expected to produce aerogels with enhanced properties, mostly by virtue of both a more uniform pore size and pore distribution. This has led to the development of continuous manufacturing processes for the synthesis of aqueous colloidal silica solutions from ion-exchange waterglass. By appropriately removing surface tension of the solvent, as well as the capillary pressure gradient that builds up within the pore walls through supercritical drying (SCD) of the wet gels, the potential pore collapse is avoided. This preserves the porous texture of the gels as the solvent is effectively extracted without developing stress on the pores while cracking and shrinking of the gels is thus avoided. Such supercritical drying process, nevertheless, entails the use of high-cost autoclaves operating at high temperature (260° C.) and pressure (˜100 bars) in order to heat and evacuate solvents that are typically highly flammable, which could also represent a safety hazard during the manufacturing of aerogel products. As such, there remains a need for a cost-effective method of producing aerogel products that have improved mechanical properties.

### SUMMARY OF THE DISCLOSURE

An all-around low-cost strategy for the production of silica-based aerogel composite materials is presented, which comprises purified sodium silicate solution (also referred as waterglass) and commercial cellulose-based fiber (such as recycled paper or 85% newsprint) as components. An economical, straightforward ion-exchange procedure may be used for the purification of the waterglass, yielding a colloidal solution with high contents of silica nanoparticles that result in better thermal performance due to the presence of a refined structure skeleton and superlative pore integrity following the removal of sodium ions and other impurities. Modifying the quantities of urea and surfactants (e.g., an anionic surfactant such as sodium dodecyl sulfate (SDS) and a cationic surfactant such as cetyltrimethylammonium bromide (CTAB)), which may be introduced as pore developing agents during the sol-gel process to allow for the implementation of ambient pressure drying (APD) techniques of both aerogels and composite specimens, may be advantageous in accomplishing improved physicochemical properties such as porosity, density, cumulative pore volume, and specific surface area that would have a direct impact on the improvement of values of thermal conductivity of the aerogel-based materials.

Through a scalable, vacuum-filtration-assisted procedure, as well as the inclusion of cellulose-based fibers that may be generated from recycled paper and are widely available, composite materials can be produced. These exemplary materials not only achieve outstanding values of maximum compressible stress at relatively low strain rate when compared with ceramic-fiber-based counterparts, but also provide an improved balance between elasticity and rigidity that allows for easy, safe machinability of the generated silica aerogel composites. Such attributes position these functional materials as alternatives in the development of thermal-performance-enhanced products with a broad range of applicability at the industrial level.

### BRIEF DESCRIPTION OF THE DRAWINGS

Various embodiments of the present disclosure will be understood more fully from the detailed description given below and from the accompanying drawings. In the drawings, like reference numbers may indicate identical or functionally similar elements. Embodiments are described in detail hereinafter with reference to the accompanying figures, in which:

FIG. 1A is an optical image of cellulose-based fiber from 85% recycled paper useful in an embodiment of the disclosure.

FIG. 1B is a diagrammatic view of main components of a cellulose fiber/silica aerogel composite according to an embodiment of the disclosure.

FIG. 1C is an optical image of a cellulose fiber/silica aerogel composite specimen according to an embodiment of the disclosure.

FIG. 1D is an image showing hydrophobic capability of cellulose fiber/silica aerogel composite material after in situ trichlorosilane surface coating according to an embodiment of the disclosure.

FIG. 2A is a schematic of the ion-exchange waterglass procedure as described in Example 1.

FIG. 2B is a SEM image showing microstructure of the ion-exchange waterglass-based aerogel of Example 1.

FIG. 2C is a thermal conductivity vs sintering temperature graph for both non-ion-exchange and ion-exchange waterglass-based aerogels of Example 1.

FIG. 2D is an isotherm curve and pore volume plots from BET/BJH tests for both non-ion-exchange and ion-exchange waterglass-based aerogels respectively of Example 1.

FIG. 3A is a thermal conductivity vs sintering temperature graph for ion-exchange waterglass-based aerogels with different co-surfactant ratios of Example 4.

FIG. 3B is a SEM image showing typical mesoporous microstructure of ion-exchange waterglass-based aerogels of Example 4.

FIG. 3C is a thermal conductivity and porosity vs CTAB ratio graph.

FIG. 3D is a BET SSA and average particle size vs CTAB ratio graph for silica aerogels with optimal quantities of ion-exchange waterglass and urea of Example 4.

FIG. 3E is a pore volume plot from BET/BJH tests for different co-surfactant ratios and optimal quantities of ion-exchange waterglass and urea of Example 4.

FIG. 4A is a schematic of the fiber/aerogel composite material procedure as used in Example 2.

FIG. 4B is SEM images showing microstructure of cross-section area for the composite material of Example 2.

FIG. 4C is a thermal conductivity vs aerogel weight percentage graph for composite materials with different co-surfactant ratio of Example 2.

FIG. 4D is a stress vs strain (40% rate) graph for composite materials with different co-surfactant ratio and monolithic aerogel material of Example 6.

FIG. 5 is a flowchart of the synthesis of ion-exchange-sodium-silicate-based aerogel as used in Example 1.

FIG. 6A, FIG. 6B, and FIG. 6C are element mapping Energy Dispersive Spectroscopy (“EDS”) analysis for aerogel materials of Example 1.

FIG. 7 is a thermal conductivity vs sintering temperature graph for aerogel materials with 1:1 SDS/CTAB ratio and different urea concentration and ion-exchange waterglass weight percentage of Example 3.

FIG. 8 is a thermal conductivity and porosity vs urea concentration graph for aerogel materials with 1:1 SDS/CTAB ratio and 25% weight ion-exchange waterglass of Example 3.

FIG. 9 is a BET specific surface area and porosity vs urea concentration graph for aerogel materials with 1:1 SDS/CTAB ratio and 25% weight ion-exchange waterglass of Example 3.

FIG. 10 is an x-ray diffraction (XRD) spectrum for aerogel materials with 1:1 SDS/CTAB ratio and 25% weight ion-exchange waterglass, including 4.125 and 6.875 mol/L of urea respectively of Example 3.

FIG. 11 is a weight loss % vs Temperature curve (TGA test) for aerogel materials with 6.875 mol/L of urea and 25% weight percent ion-exchange waterglass, including different SDS/CTAB molar ratios of Example 5.

FIG. 12 is an x-ray diffraction (XRD) spectrum for aerogel materials with 6.875 mol/L of urea and 25% weight percent ion-exchange waterglass, including different SDS/CTAB molar ratios of Example 5.

FIG. 13 is a SEM image of surface of cellulose fiber/silica aerogel composite material showing typical fiber/aerogel interaction of Example 2.

### DETAILED DESCRIPTION OF THE DISCLOSURE

The following is a description of a non-limiting method of the present disclosure used to create exemplary aerogels. Although the claimed subject matter will be described in terms of certain embodiments and examples, other embodiments and examples, including embodiments and examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit or upper limit value) and ranges between the values of the stated range.

A goal of the present disclosure is to capitalize on the low-cost of ion-exchanged waterglass as a silica source and/or a cellulose-based fiber as matrix reinforcement agent, as well as to leverage the synergic effect of SDS and CTAB as surfactants in order to accomplish aerogel-based solutions that have improved thermal performance, in addition to being commercially feasible for large-scale and practical applications in the industrial sector, ensuring high standards of repeatability of the results and advantageous performance/cost relationship. By leveraging the benefits of ion-exchange sodium silicate solution as the silica source, as well as the use of surfactants, for example, sodium dodecyl sulfate (SDS) and cetyltrimethylammonium bromide (CTAB), the resulting silica aerogel precursor obtained by an ambient pressure drying (APD) technique may be combined with cellulose-based fiber to produce a composite material that yields a combination of significantly low thermal conductivity (e.g., about 30 mW/m·K or less) and improved mechanical properties (e.g., about 1900 kPa maximum compressive stress at a 40% or 50% strain rate). Such a combination of components and process parameters provide an overall low-cost alternative for the production of aerogel-based, eco-friendly solutions that are suitable for energy efficient applications at the industrial level. In order to address the cost and safety hazards associated with waterglass-based aerogels, surface modification treatments on the wet gels and/or the addition of compatible surfactants during synthesis may be employed to replace the costly supercritical drying method in favor of the ambient pressure drying (APD) technique. Surfactants, in particular, leverage the ability to form micelles at certain concentrations during hydrolysis, which may facilitate the incorporation of the aqueous phase into the micellar domains in the organic phase that may result in a sharp decrease of the interfacial tension to negligible values, therefore allowing the use of APD procedures. Furthermore, surfactants play a critical role in the sol-gel process for the development of silica aerogels, with only a gel skeleton of macroporous morphology being obtained in the absence of any surfactant as a result of a noticeable phase separation of the condensates of hydrophobic nature. Hence, surfactants are believed to be a determinant factor that heavily influences the porosity of the aerogel. In some embodiments, a mixture of surfactants may be used to improve physicochemical properties, in contrast to a single surfactant, due to synergic effects, not only when used in the production of aerogel-based solutions, but also in a number of industrial applications such as flotation, dispersion, emulsification, drug delivery, corrosion inhibition, and nanolithography among others. Cetyltrimethylammonium bromide (CTAB) for instance—a cationic surfactant—is responsible for the change of the gel skeleton structure from a coarse granular morphology to continuous fiber as its concentration gradually increases. Another benefit of including CTAB during synthesis of silica aerogels is the decrease of the extent of phase separation that would result from using precursors from the siloxane groups and water as solvent, with the surfactant being responsible for promoting miscibility of water and the organic components present, therefore overcoming the strong hydrophobicity of the siloxane networks. On the other hand, using the anionic surfactant sodium dodecyl sulfate (SDS) for the synthesis of silica-based aerogels may not have a significant effect on the physical properties (such as porosity, density, cumulative pore volume, and specific surface area) of the aerogels when compared with conventional silica aerogels produced without the use of any surfactant. Moreover, no appreciable difference is observed between the microstructure of aerogels prepared with SDS and without surfactants. As detailed herein, surfactant-induced self-assembly may be used to adequately control the morphology of porous nanostructures in aerogels, which, in turn, regulates their thermal insulation performance.

Improvement of mechanical properties of aerogels described herein can be achieved by incorporating a fiber matrix in the preparation of fiber/aerogel composite products. Of particular interest are cellulose-based fibers, which are also referred to as “green” fibers, that have a relative low-cost and are environmentally-friendly in nature. Cellulose-based fibers are also easy to produce-typically obtained from paper, such as recycled paper—and versatile.

According to embodiments of the disclosure, a method for forming the ceramic aerogel (also referred to herein as “aerogel composite”) includes contacting a ceramic precursor, an additive, an anionic surfactant, and a catalyst comprising an acid or a base to form a mixture. The ceramic aerogel further includes a plurality of fibers dispersed therein. In some embodiments, the ceramic precursor is sodium silicate, tetramethylorthosilicate (TMOS), tetraethylorthosilicate (TEOS), silanes, or the like. In some embodiments, the ceramic precursor is an ion-exchanged sodium silicate. In other embodiments, one or more additional ceramic precursors are used to form the mixture.

In some embodiments, the amount of ceramic precursor is 10 to 50% by weight, 15 to 40% by weight, or 20 to 30% by weight based on the total weight of the ceramic precursor, the additive, the anionic surfactant, and cationic surfactant.

In some embodiments, the ion-exchanged sodium silicate is obtained by contacting sodium silicate with a cation exchange resin. In some embodiments, the sodium silicate is an aqueous solution of sodium silicate, such as 5%, 10%, 15%, or 20% sodium silicate in water. In some embodiments, the cation exchange resin is a strong acid cation exchange resin. Further, in some embodiments, the cation exchange resin is washed one or more times with, e.g., deionized water prior to contacting the cation exchange resin with the sodium silicate.

In some embodiments, the additive is a pore forming additive and/or a gas-forming additive. In some embodiments, the additive is urea or an aqueous urea solution. In some embodiments, the additive is present at 5 to 10%, 5 to 9.5%, 5.5 to 9.5%, 6 to 9%, about 5.5%, about 6%, about 7%, about 8%, or about 9% by weight based on the total weight of the ceramic precursor, the additive, the anionic surfactant, and the cationic surfactant. In some embodiments, the aqueous urea solution has a concentration of 1 to 30 mol/L, 2 to 20 mol/L, 3 to 15 mol/L, 4 to 10 mol/L, 4 to 7 mol/L, about 4 mol/L, about 5 mol/L, about 6 mol/L, about 7 mol/L, about 8 mol/L, or about 10 mol/L. In other embodiments, one or more pore-forming and/or gas-forming additives are used.

In some embodiments, the anionic surfactant includes sodium dodecyl sulfate (SDS), alkyl sulfate salts, alkyl phosphate salts, diethylhexyl sodium sulfosuccinate (DSS), diethylhexyl sulfosuccinate (AOT), taurodeoxycholic acid sodium salt (TDCA), or combinations thereof. In some embodiments, the anionic surfactant is SDS. In some embodiments, the anionic surfactant is present at up to 2% by weight, 0.05 to 1.5% by weight, 0.10 to 1% by weight, 0.13 to 0.66% by weight, 0.10 to 0.80% by weight, or 0.2 to 0.8% by weight based on the total weight of the ceramic precursor, the additive, and the cationic surfactant.

In other embodiments, the cationic surfactant is a quaternary ammonium salt, such as cetyltrimethyl ammonium bromide (CTAB), hexadecyltrimethylammonium bromide, or combinations thereof. In some embodiments, the cationic surfactant is present at up to 2% by weight, 0.05 to 1.5% by weight, 0.10 to 1% by weight, 0.17 to 0.84% by weight, 0.20 to 0.90% by weight, or 0.3 to 0.8% by weight based on the total weight of the ceramic precursor, the additive, the anionic surfactant, and the cationic surfactant.

In some embodiments, a molar ratio of the anionic surfactant to the cationic surfactant is 5:1 to 1:5, 3:1 to 1:3, 2:1 to 1:2, about 5:1, about 2:1, about 1:1, about 1:2, or about 1:5. In some embodiments, the total concentration of anionic and cationic surfactant is 0.01 to 0.25 mol/L, 0.05 to 0.20 mol/L, 0.10 to 0.15 mol/L, about 0.10 mol/L, about 0.15 mol/L, about 0.05 mol/L, or about 0.20 mol/L.

In some embodiments, the mixture provides for the inclusion of a catalyst, which may be an acid or a base. In some embodiments, the catalyst includes an aqueous acid, such as hydrochloric acid (HCl), sulfuric acid (HSO₄), nitric acid (NO₃), acetic acid (CH₃COOH), or the like. In some embodiments, the catalyst includes a base such as sodium hydroxide (NaOH), ammonium hydroxide (Na₄OH), or the like. In some embodiments, following the contact with the catalyst, the mixture has a pH of 1 to 5, 2 to 4, or 1.6 to 1.8. In some embodiments, following contact with the catalyst, the mixture has a pH of 8 to 11, 9 to 10.5, or 9.5 to 10.

According to some embodiments of the disclosure, the mixture is heated to form a precursor gel. In some embodiments the mixture is heated to a temperature of up to 100° C., 50 to 100° C., 40 to 90° C., 50 to 80° C., or 60 to 70° C. In some embodiments, the mixture is heated for about 15 minutes to 18 hours, 1 to 15 hours, 1 to 10 hours, up to 18 hours, at least 18 hours, 18 to 36 hours, or about 18 hours.

In an embodiment, the plurality of fibers is mixed with the precursor gel to form a fiber containing precursor gel. In some embodiments, the fibers are cellulose-based fibers. In other embodiments, at least a portion of the fibers are cellulose based fibers. In some embodiments, the fibers include solid fibers or hollow fibers, or both. In an embodiment, the plurality of fibers is mixed with the precursor gel before the drying stage. In some embodiments, the ceramic aerogel consists of aerogel and fibers. In some embodiments, the ceramic aerogel includes 20 to 80% by weight, 30 to 70% by weight, 40 to 60% by weight, or about 50% by weight of aerogel and a balance consisting of fibers.

In some embodiments, the precursor gel is washed. In some embodiments, the precursor gel is washed with water. In some embodiments, the precursor gel is heated to a temperature of about 50-55° C. In some embodiments, the precursor gel is washed by replacing the water about 4-5 times. In some embodiments, the washing process takes at least 24 hours. In some embodiments, the washing process lasts until the aerogel precursor is fully transparent. In some embodiments, the washing process lasts until all byproducts and/or unreacted additives or surfactants have been removed.

In some embodiments, the fiber containing precursor gel is dried. In some embodiments, the drying is performed using ambient pressure drying. In some embodiments, the ambient pressure drying techniques is accomplished in an oven pre-heated to about 40° C. to 100° C., 50° C. to 80° C., or about 60° C.

In some embodiments, the method of forming a ceramic aerogel further includes calcining the dried precursor gel. In an embodiment, the precursor gel is calcinated at a temperature between about 300 and 600° C.

The present disclosure, in various examples, provides for the creation of a ceramic aerogel made by the method of claim 1. In some embodiments, the ceramic aerogel is disposed on at least a portion of a plurality of fibers. In other embodiments, the ceramic aerogel is disposed on all the plurality of fibers.

In some embodiments, the ceramic aerogel has a hierarchical pore gradient. In some embodiments, the pores have a size between 1 to 200 nm, 1 to 150 nm, or 1 to 125 nm. In some embodiments, an average pore size is 1 to 20 nm, 5 to 15 nm, or about 10 nm. In some embodiments, the pore volume per pore width is greater than 0 to 0.15 cm³/g, 0.01 to 0.10 cm³/g, or 0.01 to 0.07 cm³/g. In some embodiments, the porosity of the ceramic aerogel is greater than 70%, greater than 75%, greater than 80%, greater than 85%, greater than 90%, greater than 95%, 70 to 99.9%, or 80 to less than 100%.

In an embodiment, the ceramic aerogel includes a plurality of particles. In some embodiments, the particles have an average particle size of 10 to 25 nm.

In an embodiment, the ceramic aerogel has a thermal conductivity as low as 15 mW/m·K. In other embodiments, the ceramic aerogel has a thermal conductivity of 15 to 65 mW/m·K, less than 50 mW/m·K, less than 40 mW/m·K, less than 35 mW/m·K, less than 30 mW/m·K, less than 25 mW/m·K, 20 to 50 mW/m·K, or 24 to 30 mW/m·K. In some embodiments, the ceramic aerogel has a 1900 kPA maximum compressive stress at about 40% strain rate. In other embodiments, the ceramic aerogel has a maximum compressive stress between 1000 and 1900 kPA at about 40% strain rate.

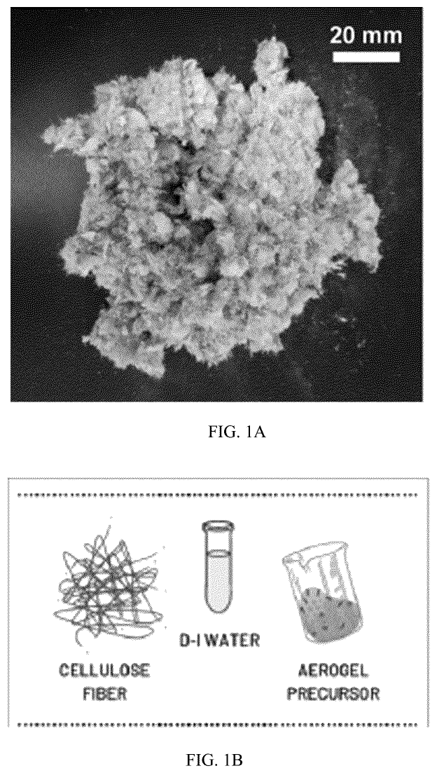

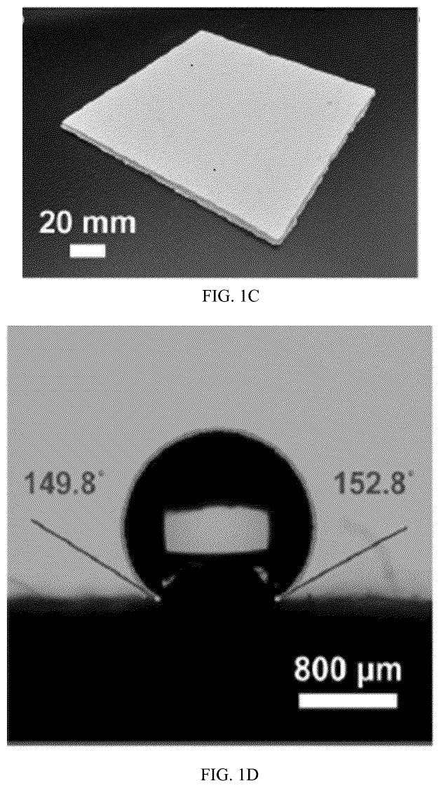

The ceramic aerogel may be formed into a variety of shapes and sizes for any desired application thereof. An example of a ceramic aerogel sheet is shown in FIG. 1C. The ceramic aerogel has excellent machinability using standard tools. The ceramic aerogel also provides hydrophobicity, as exemplified in FIG. 1D.

### EXAMPLES

### Physical, Structural, Thermal, and Mechanical Properties Characterization:

Bulk or tapped density of aerogel materials are calculated from the relationship between the mass of the material and the volume containing such amount of material, which can be represented by Equation 1 shown below:

$${ρ}_{b} = \frac{m}{V} \qquad ( 1 )$$

Skeletal density (ρₛ) is measured by means of a pycnometry system (Micromeritics Accu-Pyc II 1340 Gas Pycnometer), which employs the gas displacement method to measure volume, and hence determines density, of the solid matter contained within the measuring chamber using highly pressurized helium gas as the measuring medium. Values of porosity of the aerogel materials are then calculated from Equation 2:

$$Porosity ( \% ) = ( 1 - \frac{{ρ}_{b}}{{ρ}_{s}} ) \cdot 100 \qquad ( 2 )$$

Specific surface area (SSA), pore size, cumulative pore volume, and nanoparticle size of aerogel materials are determined by means of nitrogen sorption isotherms (adsorption/desorption) analysis from a Surface Area and Porosity Analyzer (Micromeritics TriStar II). Previously calcinated aerogel materials (to 600° C.) are pre-treated by heating to 280° C. during 3 hours of degassing of a flowing gas used to remove any form of impurities and contaminant. Materials are subsequently cooled to cryogenic temperatures (−195° C.) under vacuum conditions during the test. The specific surface area (SSA) is calculated from the relative pressure (P/Pₒ from 0.003 to 0.3) data given by the adsorption isotherm plot and based on the Brunauer-Emmett-Teller (BET) theory. Pore size and pore volume, on the other hand, are calculated from the desorption branch of the isotherm curve using the method of Barrett, Joyner, and Halenda (BJH) based on the Kelvin model of pore filling.

The structure of the silica aerogel materials was investigated through an X-ray Diffraction System (XRD-Rigaku Ultima IV), with copper as target material for single-crystal diffraction and the X-ray detector rotating at an angle of 20 from 5° to 80°, these being typical values for data collection of powder patterns. Fourier-transform infrared spectroscopy (FTIR-Agilent Cary 630 FTIR spectrometer) was used to analyze the chemical bonding state of the finely ground aerogel materials, as well as the interfacial bonding of aerogel-based composite materials that could be relevant in order to understand their mechanical performance. The microstructure of both aerogel and aerogel/fiber composite materials was examined by Focused Ion Beam Scanning Electron Microscope (FIB-SEM, Carl Zeiss AURIGA CrossBeam).

Thermal conductivity of both aerogel and aerogel/fiber composite materials were determined through measuring instruments using the steady-state methodology. For aerogel materials, an in-house setup that complies with the ASTM C518 standard, which applies to Standard Test Methods for Steady-State Thermal Transmission Properties by means of a heat flow meter apparatus, was used. The PHFS-Ole Heat Flux Sensor from FluxTeq has been fitted to the thermal conductivity measurement setup, with the required calibration achieved by virtue of a commercial, translucent aerogel as reference. Values of thermal conductivity can be calculated using the readings for temperature of top and bottom plates, once steady heat flux between and through the material has been established. For aerogel/fiber composite materials, on the other hand, the Heat Flow Meter-100 series (HFM-100) Thermal Conductivity Measurement System from Thermtest was used, which also complies with the ASTM C518 standard. In similar fashion, pertinent calibration was accomplished by utilizing commercial materials of extruded polystyrene of the appropriate thickness and with a known value of thermal conductivity. Upon insertion of the aerogel/fiber composite materials between the upper and lower plates, and following loading of the calibration file, the system provided the value of thermal conductivity of the material once the heat flux between the plates, and through the material, had converged to a constant value over time. In regard to evaluating thermal stability of aerogel materials, thermogravimetric analysis, and differential scanning calorimetry (TGA/DSC) tests were carried out using the TA Instrument DSC SDT Q600. This test provides measurements of weight change (TGA) and true differential heat flow (DSC) on the material that are heat-treated in a nitrogen atmosphere (with a purge rate of 100 mL/minute) from room temperature (RT) to 800° C. at a rate of 25° C./minute.

Mechanical properties characterization of aerogel/fiber composite materials include uniaxial compression tests of materials with bulk dimensions of 15 mm×15 mm×6 mm, using a universal test frame (Model DS™-50KN form United Testing Systems) for testing materials up to 50 kN (11,200 lbf).

### Example 1

### Preparation of Diluted Ion-Exchange Sodium Silicate Solution (Waterglass):

A cation-exchange resin (AMBERLITE™ IRC120 H-hydrogen form | Sigma Aldrich) was washed 4-5 times for 10 minutes with deionized water before use. Sodium silicate solution (Technical Grade 40°-42° Bé | Fisher Scientific) was diluted to approximately 10% v/v using deionized water (DI H₂O) in a beaker, followed by stirring the solution with a magnetic stirrer for at least 15 minutes. Finally, the diluted waterglass was passed through an ion-exchange column loaded with the washed cation-exchange resin to obtain the ion-exchange waterglass.

### Synthesis of Ion-Exchange-Sodium-Silicate-Based Aerogel Precursor:

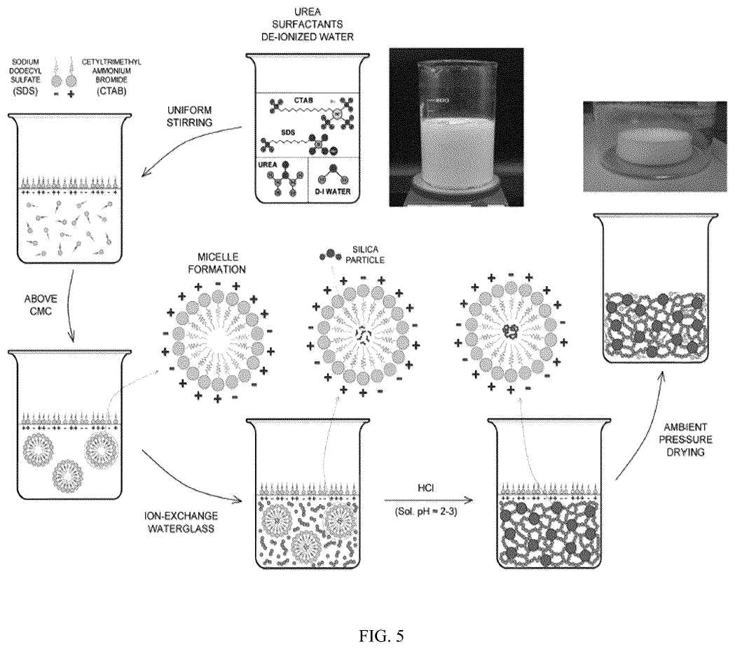

A flowchart of the synthesis of ion-exchanged-sodium-silicate-based aerogel precursor including both an anionic surfactant (SDS) and a cationic surfactant (CTAB) is shown in FIG. 5. Initially, urea [CH₄N₂O; 98% | Beantown Chemical (BTC) ] was added to approximately 400 mL of deionized water [DI H₂O] in a beaker to prepare solutions having five different concentrations (namely about 4.125, 5.5, 6.875, 11, and 16.5 mol/L), and the solution was stirred with a magnetic stirrer for at least 60 minutes until complete dilution took place. Subsequently, Sodium Dodecyl Sulfate-SDS-[C₁₂H₂₅NaSO₄; about ≥90% | Sigma Aldrich] and Cetyltrimethylammonium Bromide (CTAB) [C₁₉H₄₂BrN; High purity | VWR], were added at different surfactant ratios and at an overall co-surfactant concentration of about 0.12 mol/L, to the DI Water-Urea mixture, with continuous and uniform stirring for at least 120 minutes or until a homogeneous, white-color solution was achieved. In various examples, the total surfactant concentration (the concentration of all surfactants in solution) was 0.01 to 0.20 mol/L. Typically, the resulting solution was mixed for at least 6 hours or overnight before the next step. Once fully mixed, the diluted ion-exchanged sodium silicate obtained previously was added to the mixture at a proportion of 25 wt % and stirring was continued for at least 2-3 minutes until completely mixed with the DI Water-Urea-Surfactants solution. Hydrochloric Acid [HCl (aq); 36.5-38.0% | Capitol Scientific] was added to deionized water [DI H₂O] in a small beaker or graduated cylinder to a 50% v/v HCl/DI H₂O ratio. Finally, the diluted HCl was added to the DI Water-Urea-Surfactants-Ion-exchange Sodium Silicate mixture (25% v/v HCl/Diluted ion-exchanged sodium silicate ratio) and stirring was continued for approximately 2-3 additional minutes until fully blended in the resulting solution. The solution was transferred to a sealed plastic container (target pH of solution ≈1.6-1.8), which was closed as tightly as possible before placing it into an oven pre-heated to 80° C. for a period of 24 hours.

Following completion of the heat treatment, an aerogel precursor of white color and very smooth aspect-rather fine texture, showing little water separation at the top of the container was formed. The raw precursor was then transferred to a beaker and immersed in DI water (e.g., for washing and aging purposes). The beaker was placed on a hot plate at approximately 50-55° C. The DI water was completely replaced 4-5 times as part of the washing process during a period of at least 24 hours, or until the DI water covering the aerogel precursor was almost fully transparent and all possible byproducts and/or unreacted additive or surfactants were removed. Upon completion of the washing and aging processes, and once the excess water was removed from the beaker, the precursor was ready for post processing. For this work, post-processing included (a) drying of the aerogel precursor using an ambient pressure drying (APD) technique in an oven pre-heated to 60° C., followed by the respective calcination of the aerogel materials at 300° C., 400° C., 500° C. and 600° C., as well as (b) the preparation of aerogel precursor/cellulose-based fiber composite materials.

### Preparation of Sodium-Silicate-Based Composite Materials

Different amounts of cellulose-based fiber (Sanctuary Cellulose Fiber by Greenfiber; an optical image of a cellulose-based fiber from 85% recycled paper is shown in FIG. 1A) were used in order to study the effect of the aerogel precursor/cellulose-based fiber ratio on the physical, mechanical, and thermal properties of the composite materials. The required amount of cellulose-based fiber was blended with approximately 1.25 L of DI water—to ensure full immersion of the fiber in the liquid—for about 30 seconds using a blender. Following this, the blended fiber was transferred to a larger container and the required volume of aerogel precursor was added to the mixture, which was thoroughly mixed without any further reaction using an overhead liquid mixer, while gradually adding DI water to complete a volume of approximately 3 L to achieve adequate dispersion of the fiber. A centrifugal-pump-operated composite material making unit was used to process the previously obtained aerogel precursor/cellulose-based fiber mixture, and the resulting wet composite material specimens were then dried in an oven pre-heated to 60° C. for a period of 24-48 hours. Couch sheets were used on both sides of the composite materials during the drying process, in order to increase the water removal rate and ensure the integrity of the materials.

### Ion-Exchanged Sodium Silicate (Waterglass) Solution Principal Analysis:

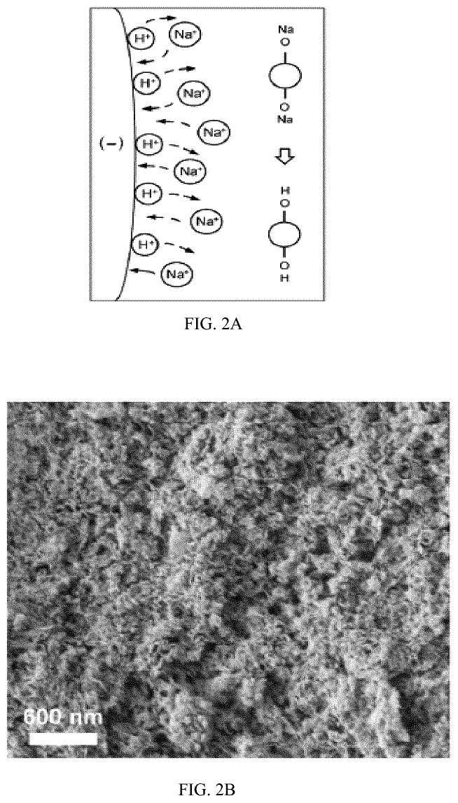

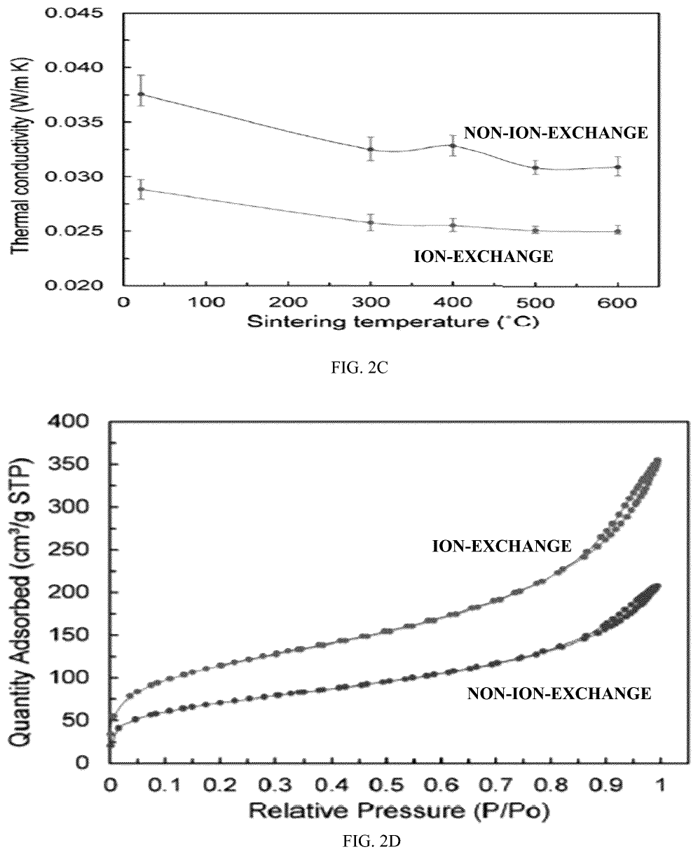

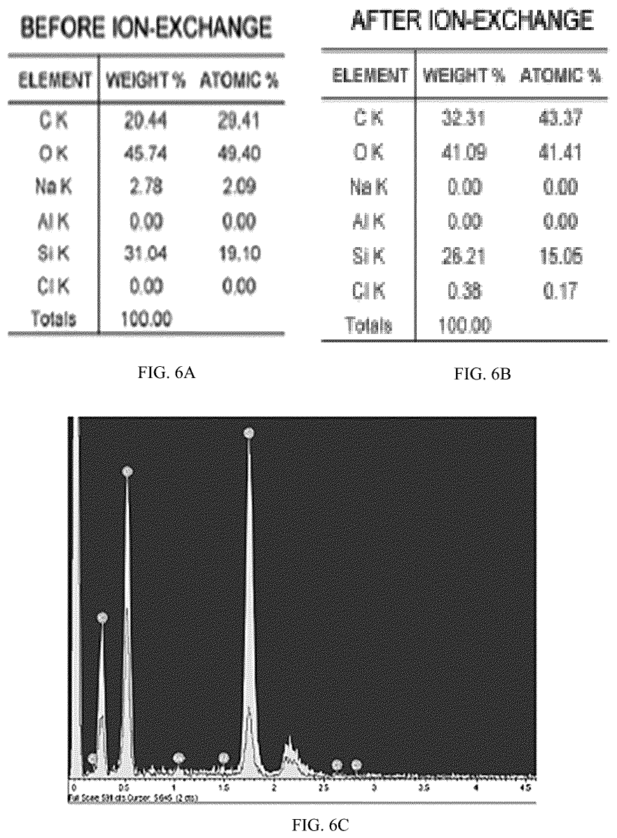

A factor in improving both thermal performance and physical properties of waterglass-based aerogels is the implementation of an ion-exchange procedure prior to synthesis of the aerogel precursor. As the diluted waterglass (in de-ionized water) was contacted with cation-exchange resin (for example, passed through a bed of cation-exchange resin), sodium ions contained in the aqueous waterglass solution were replaced by hydrogen ions, present on the resin, hence giving rise to an aqueous solution of active silicic acid as a result of the ion-exchange mechanism that takes place. This resulting active silicic acid is sometimes referred to herein as “ion-exchanged waterglass” or “ion-exchanged sodium silicate.” A schematic of this procedure is shown in FIG. 2A, which typically yielded an acidic colloidal solution with pH values between 2 and 4 that contains particles with a diameter of 2 nm or lower. Element mapping (Energy Dispersive Spectroscopy-EDS) analysis of aerogel materials that were synthesized using waterglass-based solutions prior to and after the ion-exchange procedure confirms effective removal of sodium ions from the diluted waterglass, as shown on tables of composition included in FIGS. 6A and 6B; an overlay of the spectrographs is shown in FIG. 6C. Aerogels obtained by means of this purified silica source tend to form a homogeneous bulk monolithic configuration when compared to the non-ion-exchanged waterglass counterpart, as well as featuring a uniform, dense microstructure in the nanoscale range—as shown in FIG. 2B—in part as a direct effect of the high contents of silica nanoparticles. Furthermore, aerogels produced with ion-exchanged waterglass offer a better thermal performance, by virtue of a lower value of thermal conductivity than the non-ion-exchanged waterglass specimen—as seen from FIG. 2C-which can be attributed to a refined structure skeleton and superlative pore integrity due to appropriate removal of sodium ions and other impurities that could seemingly develop blockage of the pores and a potential increment of the solid phase of the thermal conductivity of the aerogel. Lastly, aerogels produced with ion-exchange had better absorption qualities, as shown in FIG. 2D.

### Example 2

### Cellulose-Based Fiber/Aerogel Precursor Composite Materials:

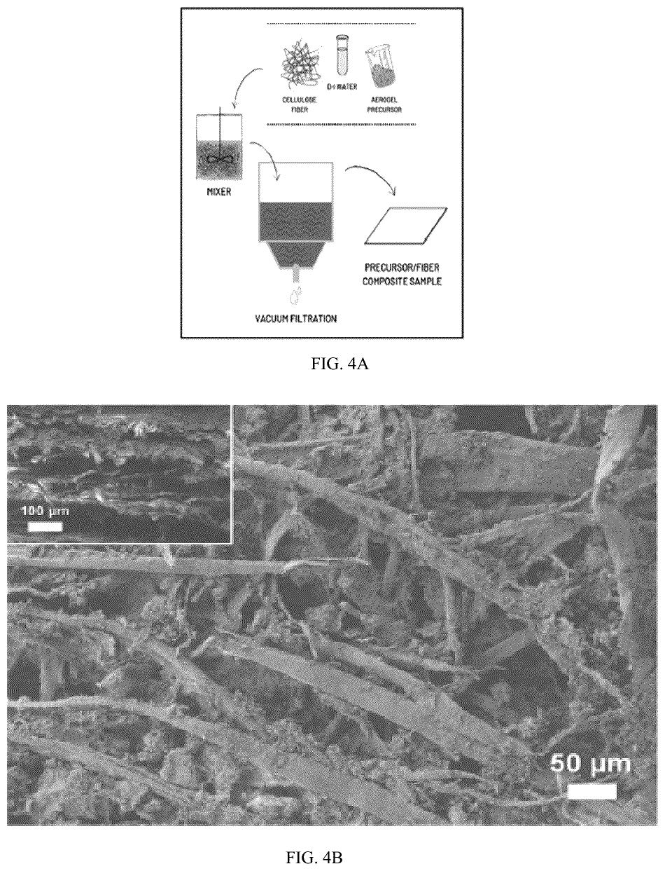

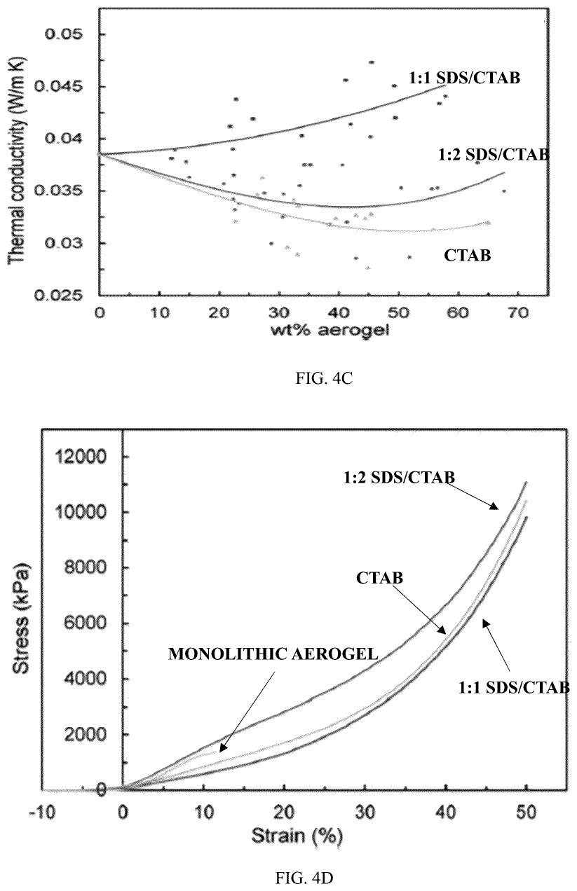

Aerogels are renowned for their brittleness and fragility. When produced in bulk, monolithic form, they possess some inherent mechanical strength, although they can rapidly collapse once the value of maximum allowable stress is achieved due to their inability to withstand loads beyond the elastic regime. Moreover, cyclic load schemes are rarely feasible since their structure is substantially damaged when the load range within the elastic regime is accomplished. To overcome such brittleness and fragility, fibers were mixed with the aerogel precursor-prior to the drying stage—to produce composite material specimens, in order to (i) take advantage of the physical properties of the fiber to introduce some degree of elasticity to the resulting product, as well as (ii) improve the thermal performance of fiber-based products by virtue of the aerogel precursor being used. FIG. 4A shows a schematic of the methodology that was used for the preparation of exemplary cellulose fiber/aerogel composite material specimens, a scalable procedure that is further explained below. Because vacuum filtration was implemented in order to subtract all the liquid from the fiber/precursor mix and allow for the safe extraction of the material from the experimental setup, a rather neat layer-upon-layer fiber/aerogel arrangement was typically achieved as revealed by the SEM image of the cross section of a specimen shown in FIG. 4B. It is noted that the methodology reported promoted a superior fiber/aerogel interaction as illustrated in the SEM image of the surface of a composite material specimen given in FIG. 13.

FIG. 4C presents the results of thermal conductivity in relation to the quantity of aerogel contained for the entire population of composite material specimens-including the three different aerogel precursors used, with the curves shown representing each of the trends for the data obtained following thermal conductivity tests. Analysis of the trend lines suggest that as the percentage of CTAB increases in the aerogel precursor, the value of thermal conductivity of the composite materials tends to decrease, with the lowest values belonging to the CTAB only precursor that has been used as a control value. Without being bound by theory, such tendency could be attributed to the distinct effect of the different concentrations of cationic surfactant (CTAB) on the resulting silica aerogel structure for the different aerogel precursors used, which may have interacted distinctively with the cellulose fiber, hence producing different fiber/aerogel morphologies that would in turn introduce dissimilarity in the thermal performance of the composite material specimens. Furthermore, values of thermal conductivity versus weight percentage of aerogel for groups of composite material specimens with similar thickness (˜ 2.2 mm) not only fairly correlate with the results in FIG. 4C, but also confirm that the best thermal performance for the SDS/CTAB based precursor (1:2 ratio)—by means of the lowest values of thermal conductivity-occurs for a weight percentage of aerogel of approximately 42%.

An exemplary ion-exchange waterglass-based aerogel obtained using the procedure detailed above demonstrated a thermal conductivity as low as 23.4 mW/m·K, with a specific surface area of 412.83 m²/g, and a porosity of 97.4%. The developed aerogel precursor/cellulose-fiber composite materials possess hydrophobic capabilities, in addition to an extraordinary combination of significantly low thermal conductivity (28.6 mW/m·K) and improved mechanical properties (˜1900 kPa maximum compressive stress at 40% strain rate) that results in unique machinability attributes using standard tools, such as saws and drills.

### Example 3

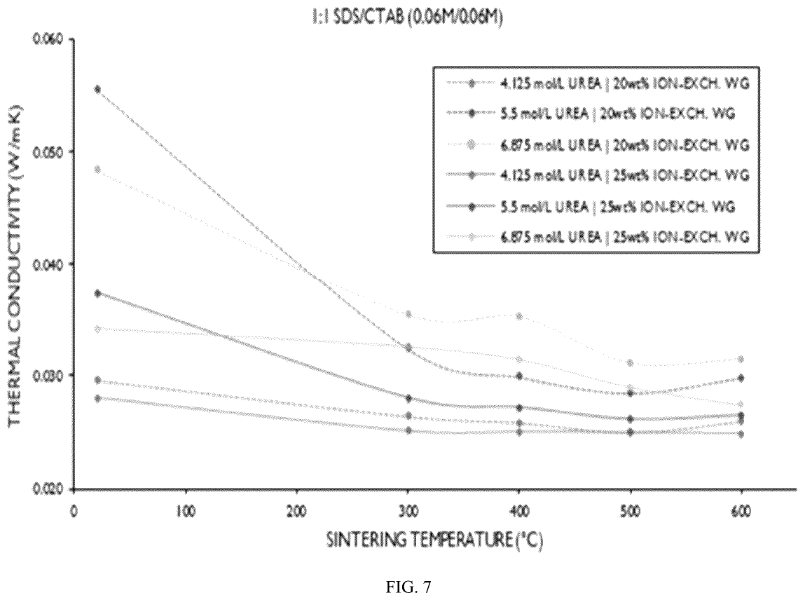

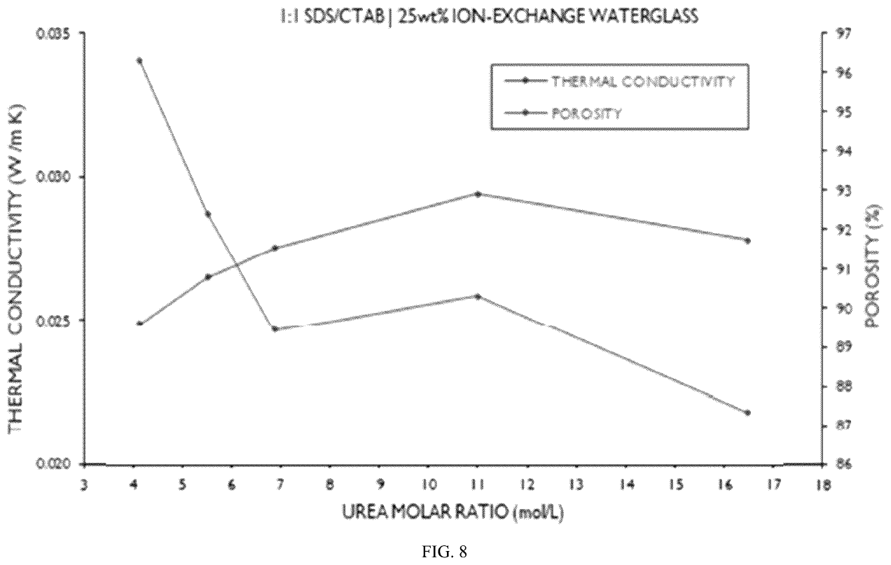

Aerogel materials with different concentrations of urea and weight percentage of ion-exchanged waterglass (relative to the total weight of the solution (e.g., solvent and solute)) were prepared in a similar manner as described in Example 1 above and the values of thermal conductivity for the materials are shown in FIG. 7. As shown, for a one-to-one mole ratio (1:1) of the surfactants (SDS/CTAB), a urea concentration of 4.125 mol/L and 25 wt % ion-exchanged waterglass yielded the best thermal performance by virtue of lower values of thermal conductivity. Two opposite trends can be seen for such surfactant ratio, with (i) values of thermal conductivity tending to increase and (ii) values of porosity decreasing as the quantity of urea increases—as shown in FIG. 8—which, without being bound by theory, could be the result of both a concurrent increment of the average pore size of the aerogel and a decrease in the number of pores that would presumably introduce a simultaneous rise in the gas and solid phases, respectively, of the thermal conductivity of the aerogel.

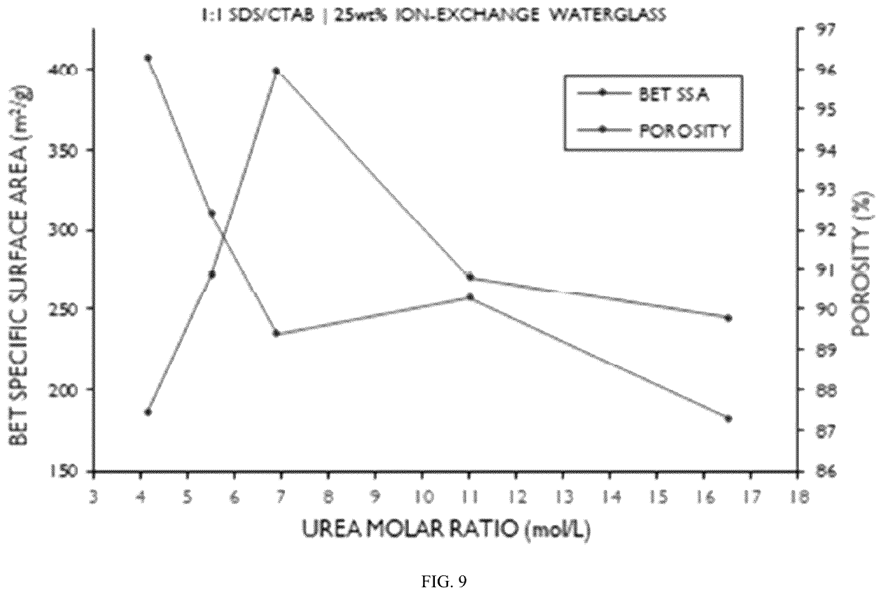

An assessment of the specific surface area (SSA) as a critical physical property of aerogels showed that, for the same one-to-one ratio (1:1) of the surfactants (SDS/CTAB), the highest value of SSA (399.2 m²/g) occurs at a urea concentration of 6.875 mol/L and 25 wt % ion-exchanged waterglass, results obtained from tests based on the Brunauer-Emmett-Teller (BET) adsorption method. In similar fashion to the case of the analysis of thermal conductivity, this highest value of SSA corresponds to one of the lowest values of porosity (˜89.4%)—as shown in FIG. 9—hence suggesting that pore size rather than quantity of pores may have a greater effect on values of total surface area of the aerogel per unit of mass. Moreover, the results confirm that aerogels obtained from ion-exchanged waterglass would both (i) absorb a much higher quantity of gas during the BET test (as show in FIG. 2D), and (ii) have a larger pore volume than the non-ion exchanged waterglass aerogel respectively, which, without being bound by theory, could be a direct consequence of an increase of the urea concentration and its subsequent in situ foaming agent effect to support pore formation, in addition to a considerable amount of open pores following removal of impurities and sodium ions accordingly.

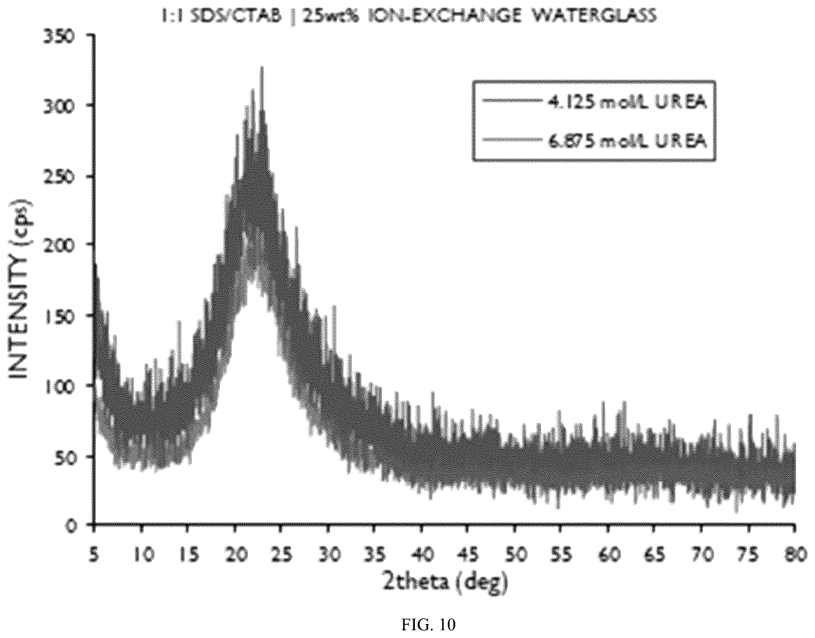

Prepared aerogels with a concentration of urea of 4.125 mol/L or 6.875 mol/L feature an amorphous nature, as suggested by the broad peak observed near 22° in the X-ray diffraction patterns shown in FIG. 10. The difference between both patterns can be attributed to a dissimilar structural evolution of Si and C prior the formation of SiC during condensation, due to gradual reaction between both C and Si, respectively.

### Example 4

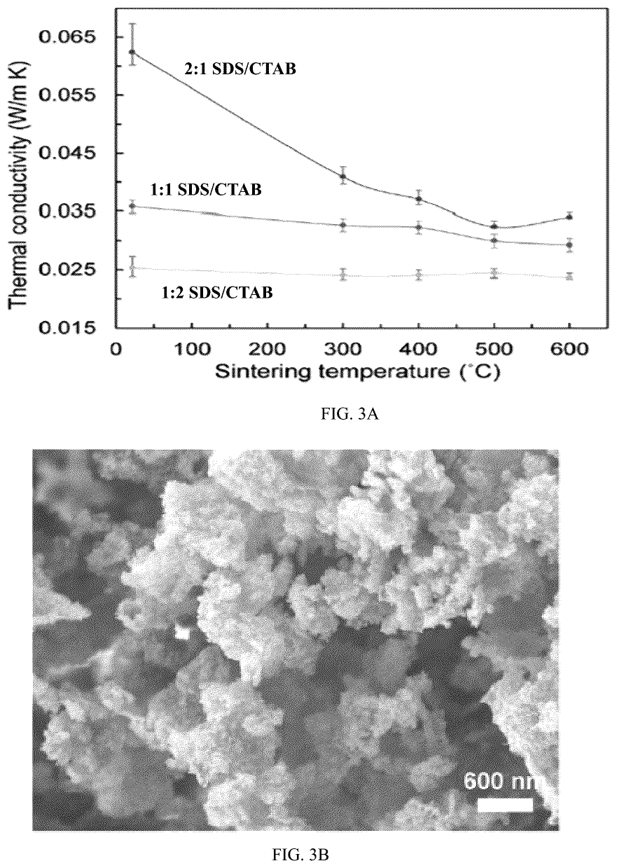

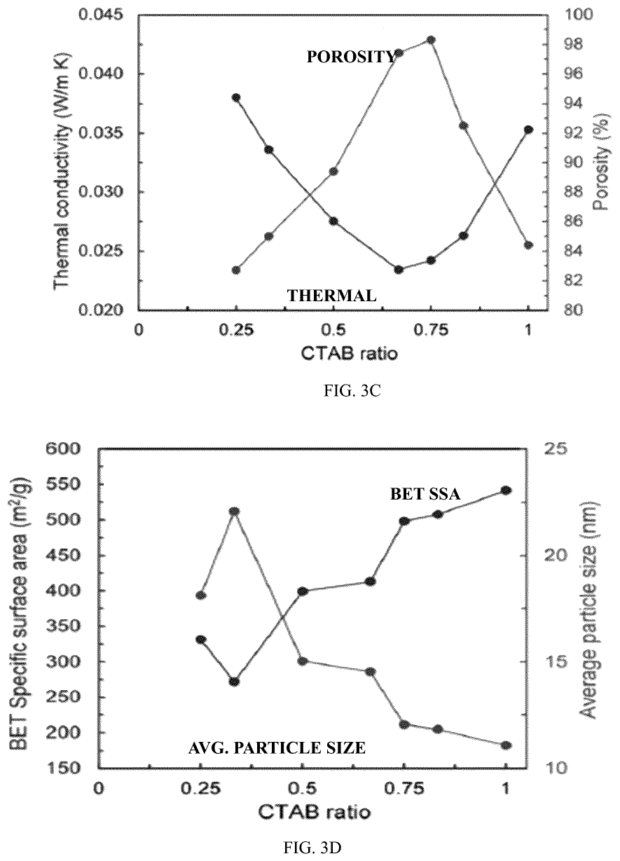

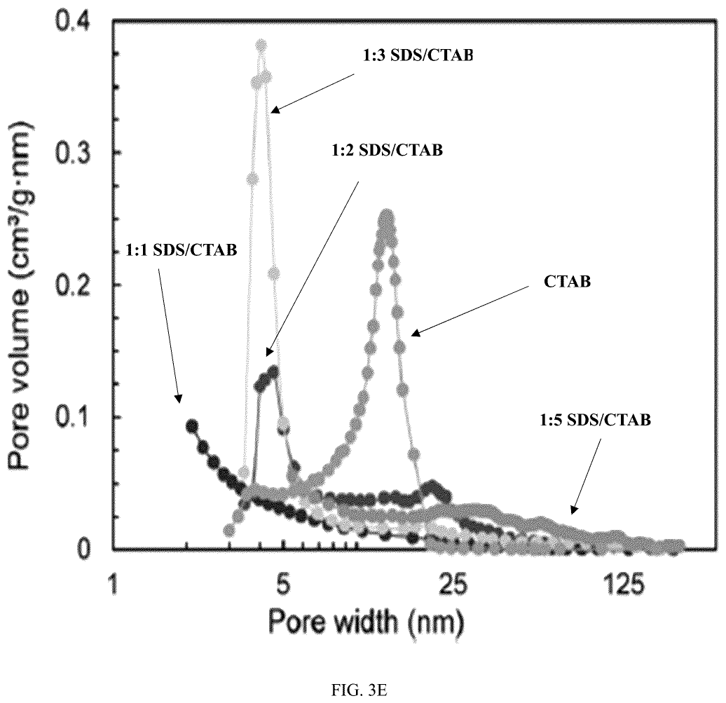

Aerogel materials with different surfactant ratios were prepared in a similar manner as described for Example 1 above. The materials were tested in an un-sintered state and at various sintering temperatures for thermal conductivity at room temperature (RT). As shown in FIG. 3A, the lowest values occurred for a 1:2 ratio (SDS/CTAB), which held true for both original state and sintered composite material specimens (at 300° C., 400° C., 500° C., and 600° C.). In all cases, SEM images showed a significant structure, which is particularly noticeable in composite material specimens that have been sintered at 600° C. as a mechanism to remove organic matter and preserve the mesoporous microstructure typical of silica aerogels as depicted in FIG. 3B. Values of thermal conductivity for sintered composite material specimens with a CTAB ratio below or above 0.66 (or 1:2 SDS/CTAB) increased, while an opposite trend is observed for values of porosity as shown in FIG. 3C, which highlights the direct, but inverse, relationship that exists between these two properties. At an overall concentration of 0.12 mol/L for SDS/CTAB, the ratio of 1:1 provided improved thermal performance by virtue of the mixed micelle formation of the anionic (SDS) and cationic (CTAB) surfactants that takes place within the mixed SDS/CTAB system as a result of the attractive Coulombic interactions between the monomers. Moreover, mixed micelles not only exhibit different physicochemical properties according to their surfactants' mole ratio, but these can also host different amounts of silica from the waterglass in their core that will eventually break through the barrier that has been formed by the surfactants' system and form the silica aerogel backbone. Silica contents in the aerogel are determined by the nature of the mixed micelles, which is, in turn, defined by the mole ratio of the surfactants.

With regard to values of specific surface area (“SSA”), from the lowest value obtained (271.96 m²/g) for a CTAB ratio of 0.33 (or 2:1 SDS/CTAB) (0.08 M SDS and 0.04 M CTAB), the SSA of sintered composite material specimens increased gradually until reaching a maximum value of 541.6 m²/g for the CTAB only composite material sample (control value) as shown in FIG. 3D. Nevertheless, values of average particle size—also determined through BET adsorption method tests-indicated an opposite tendency, having a highest value of approximately 22 nm for a CTAB ratio of 0.33, to then decrease gradually to the lowest value of 11.8 nm for the CTAB only composite material specimen. Values of porosity, on the other hand, increased steadily as the CTAB ratio also increased, although it started to decrease at a CTAB ratio of 0.75 (or 1:3 SDS/CTAB)—after reaching a maximum value in the vicinity of 98%—to drop to approximately 84% for the CTAB only composite material sample. The fact that values of SSA kept increasing beyond such CTAB ratio of 0.75, where values of porosity decreased by almost 14%, can be attributed to a significant improvement of the pore volume values for composite material specimens with a CTAB ratio beyond this mark—as shown in FIG. 3—which will actually produce higher values of surface area of the pores, even though the number of these seem to reduce by a considerable fraction. Data in connection with these relevant aerogel properties (namely thermal conductivity, SSA, pore width, average particle size, and porosity) can be found in Table 1.

TABLE 1
Values of thermal conductivity, BET specific surface area, pore width, average
particle size, and porosity for aerogel materials with 6.875 mol/L of urea and
25% weight ion-exchanged waterglass, including different SDS/CTAB molar ratios.

| | | | | | BJH | | |
|---|---|---|---|---|---|---|---|
| | UREA | | | BET | DESORPTION | AVERAGE | |
| wt % ION- | MOLAR | CO- | k | SURF. | AVG. PORE | PARTICLE | |
| EXCH. | RATIO | SURFACTANT | (W · m⁻¹ · | AREA | WIDTH | SIZE | POROSITY |
| WATERGLASS | (mol/L) | RATIO | K⁻¹) | (m²/g) | (nm) | (nm) | (%) |
| 25 | 6.875 | 1:1 | 0.0275 | 399.23 | 6.642 | 15.029 | 89.4 |
| 25 | 6.875 | 1:2 | 0.0234 | 412.84 | 13.678 | 14.534 | 97.4 |
| 25 | 6.875 | 2:1 | 0.0336 | 271.96 | 17.980 | 22.062 | 85.0 |
| 25 | 6.875 | 1:3 | 0.0242 | 498.03 | 9.449 | 12.048 | 98.3 |
| 25 | 6.875 | 3:1 | 0.0380 | 331.38 | 12.731 | 18.106 | 82.7 |
| 25 | 6.875 | 1:5 | 0.0263 | 507.56 | 18.922 | 11.821 | 92.5 |
| 25 | 6.875 | CTAB ONLY | 0.0353 | 541.56 | 10.303 | 11.079 | 84.4 |

### Example 5

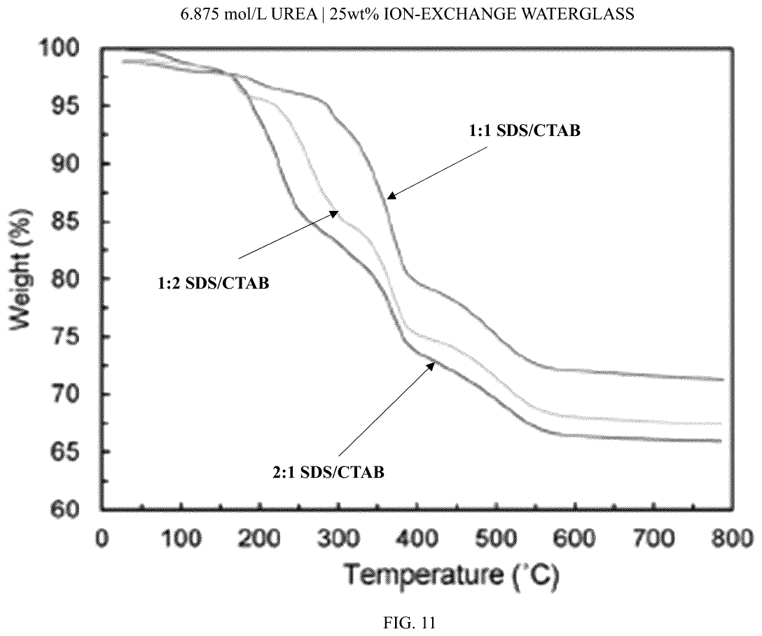

Aerogel materials with different surfactant mole ratios were prepared in a similar manner as described for Example 1 above. Thermal stability of these materials was investigated by means of TG/DSC analysis that were performed from room temperature (“RT”) to 800° C. In all cases, a congruent pattern was observed, with Weight % vs Temperature curves shown in FIG. 11, indicating that initial weight loss occurs at around 70° C. due to removal of water molecules that are still present in the composite material specimens. This was followed by a sharp weight loss that begins at around 200-300° C.—depending on the mole ratio of the surfactants in the aerogels, and that continued until approximately 550° C. for all materials analyzed, which could be attributed to the thermal degradation of organic matter existing in the composite material specimens.

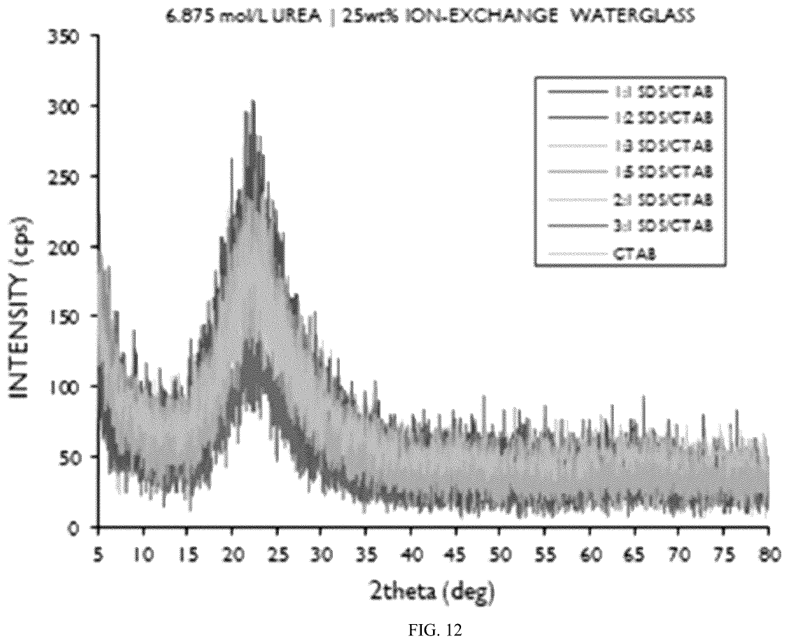

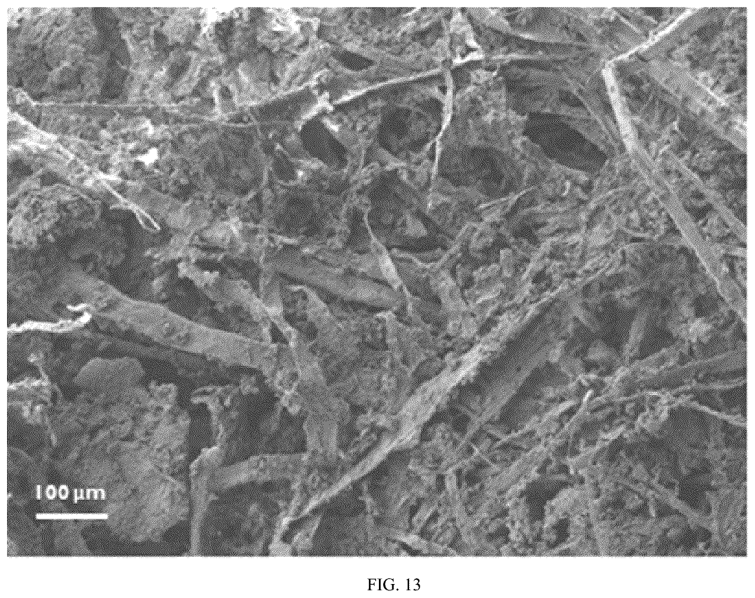

Thermal degradation of the aerogel materials beyond 550° C. was almost negligible, with the resulting weight loss totaling approximately 30% of their initial mass once the temperature had reached 800° C. This difference in weight loss could be associated to the removal of different amounts of not only organic molecules from the surfactants and urea, but also of residual, unreacted silica during heating of the specimens during the analysis, which had not been effectively extracted during the washing stage of the aerogel precursor. From the X-ray diffraction (XRD) spectra obtained—and shown in FIG. 12—only a rather noticeable peak at 2θ approximately equal to 22° was observed in all aerogel materials, which is typical of their amorphous structure and directly related to the bonding angle of the Si—O—Si siloxane functional groups that form the backbone of the silica aerogels.

### Example 6

Uniaxial compression tests performed indicate that all composite material specimens withstand at least 40% strain without collapsing, as opposed to bulk, monolithic aerogel materials that ruptured at approximately 15% strain as shown in FIG. 4D. Even though some of the composite material specimens (namely 1:1 SDS/CTAB and 1:2 SDS/CTAB) yield a maximum compressive stress—at 40% strain—that is lower than that of the monolithic aerogel specimen, these are still fully functional after going through a full cycle of loading/unloading. Nevertheless, all composite material specimens tested allow a maximum compressive stress that is notably superior (up to about 1900 kPa as presented in Table 2) to those previously reported for composite materials using ceramic fibers, which can be attributed to the nature of the fibril, with cellulose-based fibers being highly hydrophilic in essence, hence promoting a strong bonding to both adjacent threads and interfacing aerogel precursor during the drying stage. In all cases, the percentage of reduction in thickness after a 40% strain of the composite material specimens was in the range of 10-12%, thus indicating a relatively high degree of integrity of the fiber/aerogel composite material. Moreover, such good mechanical properties and rigidity of the materials translate into outstanding machinability attributes by easily enduring some of the standard manufacturing operations, specifically sawing as one of the most straightforward and useful processes, which undeniably opens up a vast range of applications for aerogel-based products at the industrial level.

TABLE S2
Values of thickness, wt % of aerogel, thermal conductivity, maximum compressive stress,
final thickness, and % of thickness reduction for cellulose fiber/silica aerogel composite
material specimens following uniaxial compression tests to 40% strain ratio.

| | | | | MAX. | | |
|---|---|---|---|---|---|---|
| | | | | COMPRESSIVE | | |
| | | wt % | k | STRESS | FINAL | THICKNESS |
| AEROGEL | THICKNESS | AEROGEL | (W · m⁻¹ · | (AT 40% STRAIN) | THICKNESS | REDUCTION |
| PRECURSOR | (mm) | (%) | K⁻¹) | (kPa) | (mm) | (%) |
| 1:1 SDS/CTAB | 3.3 | ~50 | 0.0420 | 1060 | 2.9 | ~12.1 |
| 1:2 SDS/CTAB | 2.8 | ~57 | 0.0353 | 292 | 2.5 | ~10.7 |
| CTAB ONLY | 3.3 | ~65 | 0.0320 | 1899 | 2.9 | ~12.1 |
| 1:2 SDS/CTAB | 4.5 | 100 | — | 1405 | NA | NA |
| (MONOLITHIC) | | | | (BEFORE | | |
| | | | | RUPTURING) | | |

Although several embodiments have been disclosed in detail above, the embodiments disclosed are not limiting, and those skilled in the art will readily appreciate that many other modifications, changes, and substitutions are possible in the disclosed embodiments without materially departing from the novel teachings and advantages of the present disclosure. Accordingly, all such modifications, changes, and substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112 (f) for any limitations of any of the claims herein, except for those in which the claim expressly uses the word “means” together with an associated function.

1. A method for forming a ceramic aerogel, comprising:
contacting a ceramic precursor, an additive, an anionic surfactant, a cationic surfactant, and a catalyst comprising an acid or a base to a form a mixture;
heating the mixture to form a precursor gel;
mixing a plurality of fibers with the precursor gel to form a fiber containing precursor gel; and
drying the fiber containing precursor gel.

2. The method of claim 1, further comprising contacting sodium silicate with a cation exchange resin to obtain ion-exchanged sodium silicate, and wherein the ceramic precursor is the ion-exchanged sodium silicate.

3. (canceled)

4. The method of claim 2, wherein the sodium silicate is an aqueous solution of sodium silicate comprising 10% v/v sodium silicate in deionized water.

5. The method of claim 1, wherein the additive is a pore forming and/or gas forming additive.

6. The method of claim 5, wherein the additive is urea.

7. The method of claim 6, wherein the urea is an aqueous solution having a concentration of between 4 and 20 mol/L.

8. The method of claim 1, wherein the anionic surfactant is sodium dodecyl sulfate and wherein the cationic surfactant is cetyltrimethylammonium bromide.

9. The method of claim 8, wherein the anionic surfactant and the cationic surfactant have a mole ratio of 5:1 to 1:5.

10. The method of claim 8, wherein a total concentration of the anionic surfactant and the cationic surfactant is 0.01 to 0.20 mol/L.

11. The method of claim 1, wherein the catalyst is hydrochloric acid and wherein the mixture has a pH of 2 to 4.

12-15. (canceled)

16. The method of claim 1, wherein at least a portion of the plurality of fibers are cellulose-based fibers.

17-18. (canceled)

19. The method of claim 1, wherein the ceramic precursor is present at 20 to 30% by weight based on the total weight of the ceramic precursor, the additive, the anionic surfactant, and the cationic surfactant.

20. The method of claim 1, wherein the additive is present at 5.5 to 9.5% by weight based on the total weight of the ceramic precursor, the additive, the anionic surfactant, and the cationic surfactant.

21. The method of claim 1, wherein the anionic surfactant is present at 0.13 to 0.66% by weight based on the total weight of the ceramic precursor, the additive, the anionic surfactant, and the cationic surfactant.

22. The method of claim 1, wherein the cationic surfactant is present at 0.17 to 0.84% by weight based on the total weight of the ceramic precursor, the additive, the anionic surfactant, and the cationic surfactant.

23. A ceramic aerogel made by the method of claim 1.

24. (canceled)

25. The ceramic aerogel of claim 23, wherein the ceramic aerogel has a hierarchical pore gradient.

26. The ceramic aerogel of claim 23, wherein the ceramic aerogel comprises a plurality of particles.

27. The ceramic aerogel of claim 23, wherein the ceramic aerogel comprises pores having a size of 1 micron to 500 microns.

28. The ceramic aerogel of claim 23, wherein the ceramic aerogel is a silica aerogel and is transparent.

29-30. (canceled)
